(19) United States
(12) Patent Application Publication
(10) Pub. No.: US 2026/0225022 A1
(43) Pub. Date: Aug. 6, 2026

(54) FILTER ELEMENT FOR FILTERING A GASEOUS FLUID

(71) Applicant: MANN+HUMMEL GmbH, Ludwigsburg (DE)

(72) Inventors: Daniel SCHMID, Sachsenheim (DE); Klaus GEHWOLF, Mamming (DE)

(21) Appl. No.: 19/630,716

(22) Filed: Mar. 27, 2026

Related U.S. Application Data
(63) Continuation of application No. PCT/EP2024/079470, filed on Oct. 18, 2024.

(30) Foreign Application Priority Data
Oct. 19, 2023 (DE) 10 2023 128 734.6

(51) Int. Cl. B01D 46/64; B01D 46/00; B01D 46/62; B01D 53/04; H01M 8/0662

(52) U.S. Cl. CPC B01D 46/64; B01D 46/0036; B01D 46/645; B01D 53/04; H01M 8/0687; B01D 2253/102; B01D 2258/06; B01D 2265/04; B01D 2271/027

(57) ABSTRACT

A filter element for filtering a gaseous fluid has at least two filter medium bodies arranged to be flowed through serially in a flow direction, wherein the at least two filter medium bodies each have an inflow face and an outflow face in relation to the flow direction. The at least two filter medium bodies include an outflow-side filter medium body arranged at an outflow side of the filter element in the flow direction. A safety filter covers the outflow face of the outflow-side filter medium body. At least one of the at least two filter medium bodies has an adsorbing filter medium with a granular adsorbing material. The safety filter prevents a discharge of the granular adsorbing material at the outflow side of the filter element.

### CROSS-REFERENCE TO RELATED APPLICATIONS

This application is a continuation application of international application No. PCT/EP2024/079470 having an international filing date of October 18, 2024 and designating the United States, the international application claiming a priority date of October 19, 2023 based on prior filed German patent application No. 10 2023 128 734.6, the entire contents of the aforesaid applications being incorporated herein by reference to the fullest extent permissible.

### BACKGROUND

The invention concerns a filter element for filtering, for example a gaseous fluid, for example air, for example for filtering air for a fuel cell system.

Cathode air filter elements for fuel cell systems have the task of adsorbing certain gases from the ambient air as well as of separating dirt particles. The adsorption and filtration are carried out in general by means of two different filter medium bodies. One filter medium body is formed in general of a filter medium with active carbon layers, the other filter medium body is formed in general of a filter medium with cellulose or synthetic nonwovens. In this context, the active carbon filter medium bellows for gas adsorption is usually arranged at the clean side of the filter system.

According to the prior art, a two-stage filter element is provided with a prefiltration by means of a filter medium body of a nonwoven which covers an upstream side and optionally lateral side faces.

US 11,149,699 B2 discloses a filter element for an air filter assembly of a motor which includes a primary filter medium and a secondary filter medium. The primary filter medium includes a plurality of folds which include first fold edges at an inlet face of the primary filter medium and second fold edges at an outlet face of the primary filter medium. The first and second fold edges extend from a first transverse side to a second transverse side of the primary filter medium. The secondary filter medium is formed of a nonwoven material and includes a first section arranged at the inlet face of the primary filter medium, a second section attached to the first transverse side of the primary filter medium, and a third section attached to the second transverse side of the primary filter medium.

US 2013/0167490 A1 describes a filter assembly which includes a housing, a filter element, and a layer of air-permeable material. The housing includes an inlet and an outlet. The filter element is arranged inside of the housing and includes an upstream face, a downstream face, and a first end face which is facing the inlet and extends between the upstream and the downstream faces. The layer of air-permeable material is fastened to the filter element and covers the upstream side and a portion of the first end face exposed to the inlet.

### SUMMARY

It is an object of the invention to provide a filter element for filtration of, for example a gaseous fluid, for example air, for example for filtering air for a fuel cell system.

The aforementioned object is solved according to an aspect of the invention by a filter element for filtering, for example a gaseous fluid, for example air, for example for filtering air for a fuel cell system, including at least two filter medium bodies which may be flowed through serially in a flow direction, each including an inflow face and an outflow face, wherein at least one of the at least two filter medium bodies includes an adsorbing filter medium with a granular adsorbing material, wherein a safety filter covers the outflow face of that one of the at least two filter medium bodies arranged at the outflow side, and wherein the safety filter prevents an outflow-side discharge of the granular adsorbing material.

Embodiments of the invention result from the further description and the accompanying drawings.

According to an aspect of the invention, a filter element for filtering, for example a gaseous fluid, for example air, for example for filtering air for a fuel cell system, is proposed, including at least two filter medium bodies which may be flowed through serially in a flow direction, which each include an inflow face and an outflow face, wherein at least one of the at least two filter medium bodies includes an adsorbing filter medium with a granular adsorbing material. In this context, a safety filter covers the outflow face of that one of the at least two filter medium bodies arranged at the outflow side, and wherein the safety filter prevents an outflow-side discharge of the granular adsorbing material.

The proposed filter element includes at least two filter medium bodies, an inflow-side filter medium body for filtration of particles, for example formed of cellulose and/or of a nonwoven, as well as an outflow-side filter medium body, for example formed with active carbon, for adsorption and/or absorption of gases.

In the outflow-side filter medium body which, for example may include granular active carbon, it may happen, as a result of the manufacturing process of the active carbon filter medium bellows, that carbon particles are located between the folds of the filter medium of the filter medium body which may reach the clean side of the filter system and may damage the fuel cell. In order to prevent this, therefore a safety filter, for example an air-permeable nonwoven, is also incorporated and is connected circumferentially seal-tightly to the active carbon filter medium bellows. The safety filter prevents that particles may fall out of the filter medium body.

It may be prevented in this way that particles of the active carbon filter medium bellows may be discharged to the outflow side of the filter element. A damage to the downstream fuel cell system may thus be prevented.

According to an embodiment of the filter element, the outflow-side filter medium body may include a circumferential lateral band at its end faces which are arranged transversely to the outflow face. For example, in this context the safety filter may be seal-tightly connected, for example glued or fused, to an outflow-side rim of the lateral band. The lateral band seals the end faces of the filter medium body.

Therefore, it may be prevented in this manner that particles of the active carbon filter medium bellows are discharged to the outflow side of the filter element because the safety filter is thus seal-tightly connected to the outflow-side filter medium body.

According to an embodiment of the filter element, the rim of the lateral band may project in flow direction at least in sections past the outflow face of the outflow-side filter medium body. In this way, the safety filter may be connected directly to the rim of the lateral band, namely either to an end face of the rim or to the inwardly oriented side of the rim.

According to an embodiment of the filter element, the safety filter may be glued or fused to an end face of the projecting rim of the lateral band. In this manner, the safety filter may be seal-tightly connected directly to the lateral band in a simple manufacturing step.

According to an embodiment of the filter element, the safety filter may be arranged inside of the projecting rim of the lateral band and glued or fused to the rim of the lateral band. In this embodiment, the safety filter may be also glued directly in the lateral band gluing process.

According to an embodiment of the filter element, the safety filter may be incorporated in a bonding of the lateral band to the filter medium of the outflow-side filter medium body, for example may be glued. In this way, the manufacturing process of the filter element may be realized particularly cost-efficiently.

According to an embodiment of the filter element, at least one part of the lateral band may project past the outflow face of the filter medium body at least at two opposed end faces of the outflow-side filter medium body and may be folded, in flow direction at the outflow side, over the safety filter. For example, the at least one part of the lateral band may be seal-tightly glued to the safety filter.

In this way the safety filter may be glued directly to the lateral band in the lateral band bonding process. For this purpose, the lateral band may project, for example about 1 to 2 mm, at the outflow face of the outflow-side filter medium body and may also be provided with adhesive in this region. In this way, the safety filter may be glued in the lateral band bonding process to the lateral band at the same time. The sealing action of the safety filter at the opposed end faces of the filter medium bellows ends may be realized, for example in the form of an L-angle in that a part of the lateral band at the end faces is folded over the safety filter at the outflow side and is glued to the safety filter.

According to an embodiment of the filter element, the two filter medium bodies may be arranged areally on top of each other, wherein the outflow face of the inflow-side filter medium body is arranged opposite the inflow face of the outflow-side filter medium body, and may be connected to a common seal which radially outwardly surrounds the connection region of the two filter medium bodies. With such an arrangement, the two filter medium bodies may be mechanically connected in a simple manner. At the same time, the circumferential seal operates to seal the filter element in a reliable manner between raw side and clean side upon installation in a filter housing as intended. The seal may be formed, for example of PUR (polyurethane) foam.

According to an embodiment of the filter element, the safety filter may cover the end faces of the outflow-side filter medium body and may be seal-tightly connected to the seal, for example be embedded in the seal. In this alternative embodiment, the safety filter may be pulled across the end faces and glued to the seal. In this way, the outflow face of the outflow-side filter medium body may also be secured reliably against discharge of active carbon particles.

According to an embodiment of the filter element, the safety filter may be produced by deep drawing with the shape of the outflow-side filter medium body. In this way, the mounting process of the safety filter may be realized in a simplified manner because it may be simply placed over the filter medium body.

According to an embodiment of the filter element, the inflow-side filter medium body may be configured as a particle filter and the outflow-side filter medium body as an adsorption filter, for example as an active carbon filter. In this manner, the supply air of a fuel cell system may be freed reliably from dirt particles. By means of the active carbon filter, harmful gases which may impair the function of the fuel cell may be filtered out in a beneficial manner.

### BRIEF DESCRIPTION OF THE DRAWINGS

Further advantages result from the following drawing description. In the drawings, embodiments of the invention are illustrated. The drawings, the description, and the appended claims contain numerous features in combination. A person of skill in the art will consider the features expediently also individually and combine them to expedient further combinations.

FIG. 1 shows an isometric illustration of a filter element for filtering, for example a gaseous fluid, for example air, for example for filtering air for a fuel cell system, according to an embodiment of the invention.

FIG. 2 shows a plan view of the filter element according to FIG. 1.

FIG. 3 shows a section illustration of the filter element along the section plane III-III according to FIG. 2.

FIG. 4 shows a section illustration of the filter element along the section plane IV-IV according to FIG. 2.

FIG. 5 shows a schematic section illustration of a filter element according to a further embodiment of the invention.

FIG. 6 shows a schematic section illustration of a filter element according to another further embodiment of the invention.

### DETAILED DESCRIPTION

In the drawing figures, same or same-type components are identified by like reference characters. The drawing figures show only examples and are not to be understood as limiting.

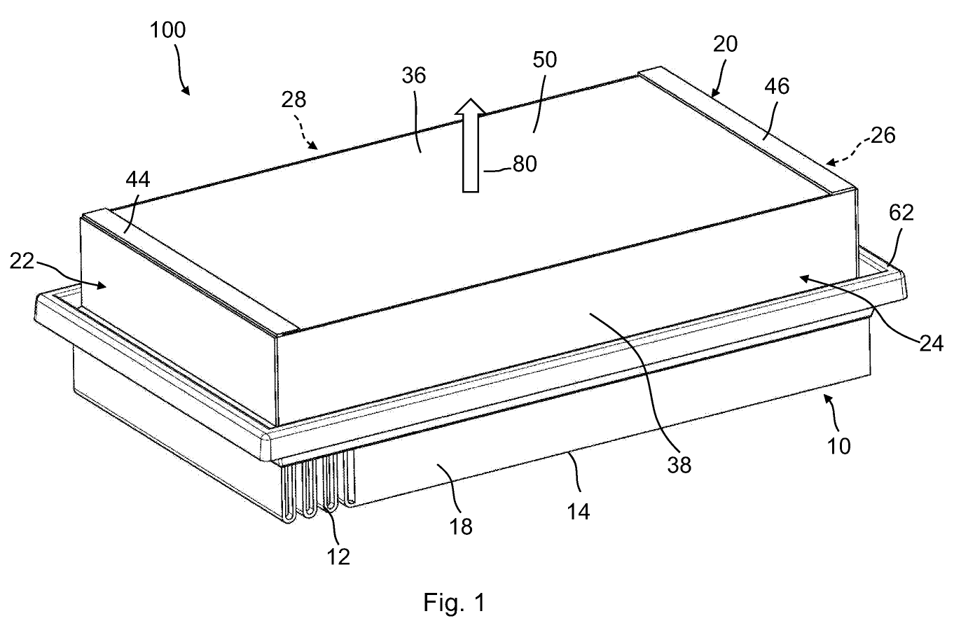

For explaining the invention, FIG. 1 shows in an isometric illustration an embodiment of a filter element for filtering, for example a gaseous fluid, for example air, for example for filtering air for a fuel cell system.

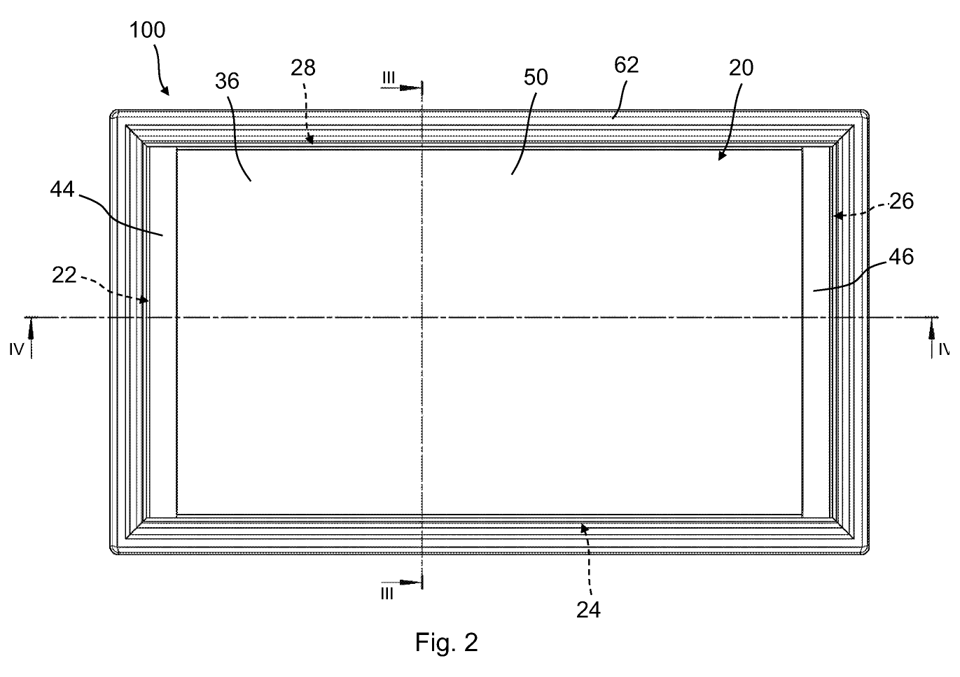

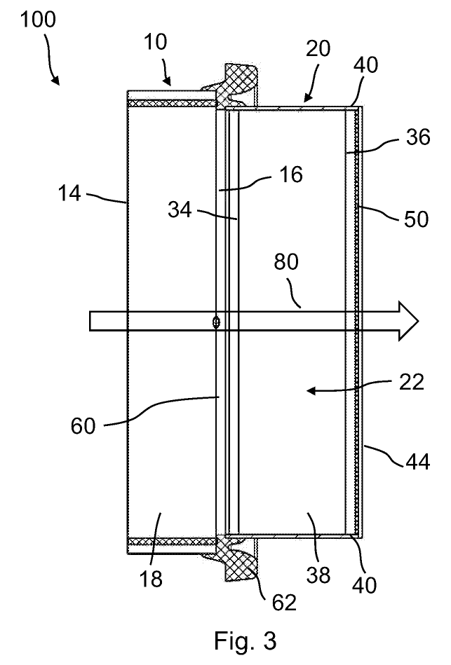

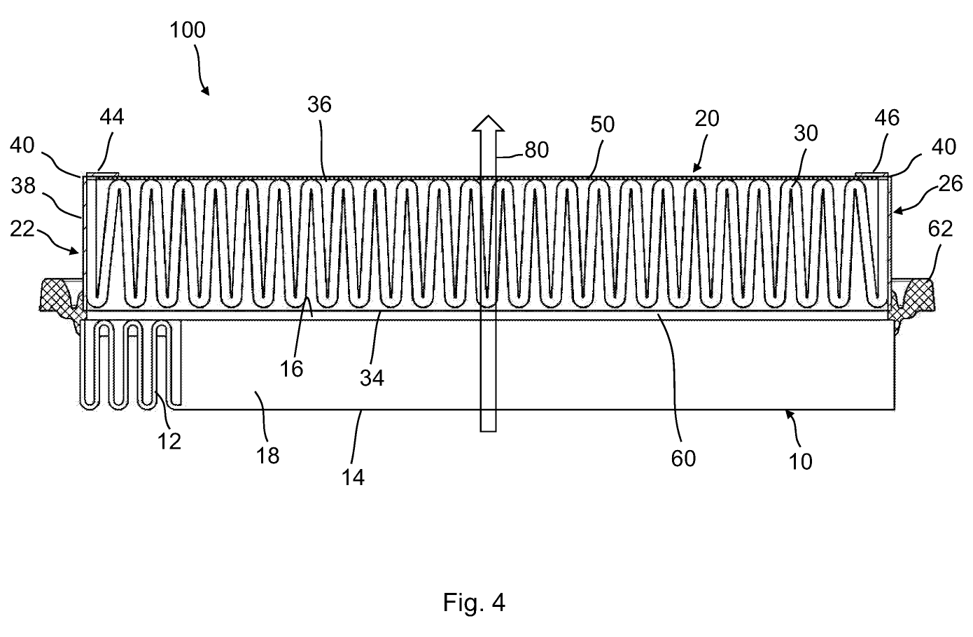

In FIG. 2, a plan view of the filter element according to FIG. 1 is illustrated while FIG. 3 shows a section illustration of the filter element along the section plane III-III according to FIG. 2 and FIG. 4 a section illustration of the filter element along the section plane IV-IV according to FIG. 2.

The filter element 100 comprises two filter medium bodies 10, 20 which may be flowed through serially in a flow direction 80. The filter medium bodies 10, 20 comprise an inflow face 14, 34 and an outflow face 16, 36, respectively.

The two filter medium bodies 10, 20 are arranged areally on top of each other. The outflow face 16 of the inflow-side filter medium body 10 is positioned in this context at the inflow face 34 of the outflow-side filter medium body 20. In the connection region 60 of the two filter medium bodies 10, 20, a radially outwardly circumferentially extending common seal 62, for example of PUR, is arranged which connects mechanically the two filter medium bodies 10, 20 and also seals reliably when installed in a filter housing of a filter system.

In this context, the inflow-side filter medium body 10 is embodied as a particle filter which filters dirt particles out of the fluid, for example air, when flowed through by the fluid. The outflow-side filter medium body 20 comprises an adsorbing filter medium 30 (FIG. 4) with a granular adsorbing material, for example active carbon.

A safety filter 50 covers the outflow face 36 of the filter medium body 20 arranged at the outflow side and prevents in this way an outflow-side discharge of the granular adsorbing material.

As may be seen in FIG. 4, the two filter medium bodies 10, 20 comprise a folded filter medium 12, 30. Because of this, the filter medium bodies 10, 20 are sealed all the way around transversely to the flow direction 80 by a lateral band 18, 38, respectively.

For example, the outflow-side filter medium body 20 comprises a circumferential lateral band 38 at its end faces 22, 24, 26, 28 arranged transversely to the outflow face 36. In this context, the safety filter 50 is seal-tightly connected to the outflow-side rim 40 of the lateral band 38, for example glued or fused.

For this purpose, the projecting rim 40 of the lateral band 38 projects in flow direction 80 at least in sections past the outflow face 36 of the outflow-side filter medium body 20. The projecting length must not be very large, for example about 1 to about 2 mm projecting length are sufficient in order to arrange the safety filter 50 inside of the projecting rim 40 of the lateral band 38 and to glue or to fuse it to the rim 40 of the lateral band 38, as may be seen in FIGS. 3 and 4. In this context, the safety filter 50 is resting directly on the fold tips of the folds of the filter medium 30.

In this way, the safety filter 50 may be incorporated into a bonding of the lateral band 38 to the filter medium 30 of the outflow-side filter medium body 20 and for example may also be directly glued therewith.

As seen in FIGS. 1 and 4, for sealing the safety filter at the filter medium bellows ends, a part 44, 46 of the lateral band 38 may project at two opposed end faces 22, 26 of the outflow-side filter medium body 20 past the outflow face 36 of the filter medium body 20. In this context, the projecting parts 44, 46 expediently may be folded in flow direction 80 at the outflow side over the safety filter 50 and glued seal-tightly to the safety filter 50. In this way, the safety filter 50 is seal-tightly glued all the way around to the lateral band 38 and seals the outflow face 36 of the filter medium body 20 reliably against discharge of active carbon particles.

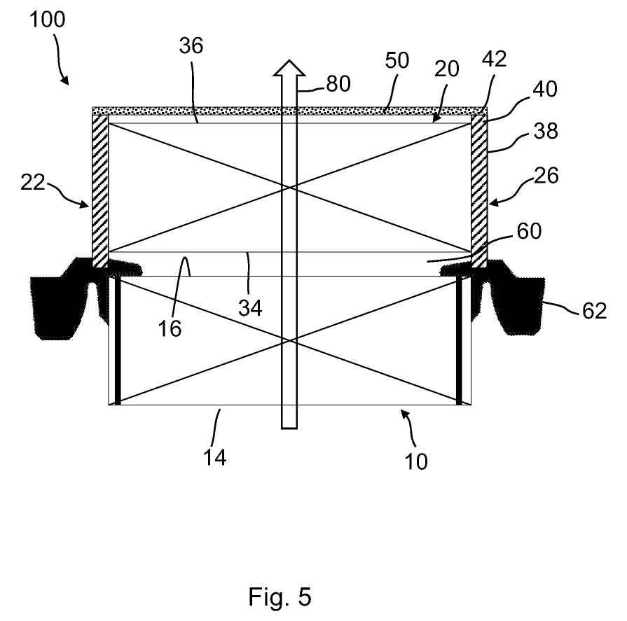

FIG. 5 shows a schematic section illustration of a filter element 100 according to a further embodiment of the invention.

The filter element 100 comprises substantially the same configuration with two filter medium bodies 10, 20 as the filter element 100 illustrated in FIGS. 1 to 4.

In contrast to the embodiment illustrated in FIGS. 1 to 4, here the safety filter 50 is glued or fused to an end face 42 of the rim 40 of the lateral band 38. In this way, a circumferentially extending reliable sealing action between the lateral band 38 and the safety filter 50 may be achieved.

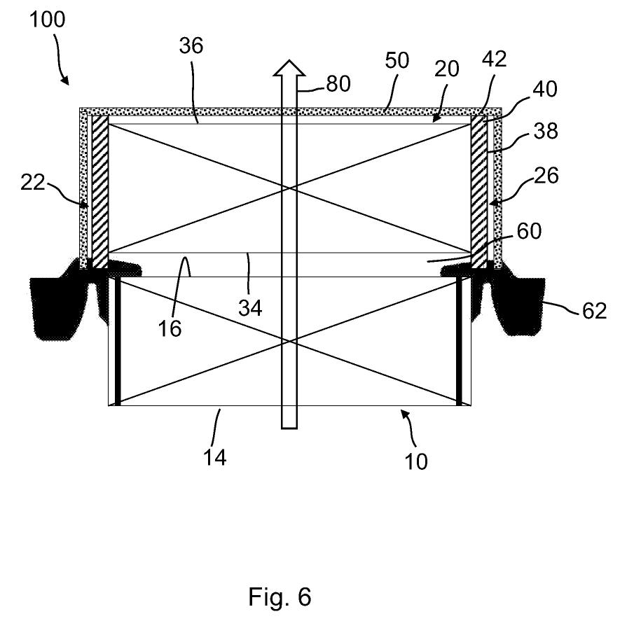

In FIG. 6, a schematic section illustration of a filter element 100 according to a further embodiment of the invention is illustrated.

In this context, the safety filter 50 covers the end faces 22, 24, 26, 28 of the outflow-side filter medium body 20 and is seal-tightly connected to the seal 62. In this way, the safety filter 50 may be embedded for example directly in the seal 62.

The safety filter 50 may thus be pulled downwardly circumferentially around the active carbon filter medium bellows of the filter medium body 20 during the manufacturing process of the filter medium body 20 until it is incorporated into the seal 62. For example, the safety filter 50 may be directly foamed in during the foaming process of the seal 62.

The safety filter 50 may be produced by deep drawing with the shape of the outflow-side filter medium body 20. Subsequently, the deep-drawn safety filter 50 may then be placed over the active carbon filter medium bellows and may be foamed on together with the seal 62.

### Reference Characters

10 filter medium body

12 filter medium

14 inflow face

16 outflow face

18 lateral band

20 filter medium body

22 end face

24 end face

26 end face

28 end face

30 filter medium

34 inflow face

36 outflow face

38 lateral band

40 rim

42 end face

44 part

46 part

50 safety filter

60 connection region

62 seal

80 flow direction

100 filter element

1. A filter element for filtering a gaseous fluid, the filter element comprising:
at least two filter medium bodies arranged to be flowed through serially in a flow direction, wherein the at least two filter medium bodies each comprise an inflow face and an outflow face in relation to the flow direction, wherein the at least two filter medium bodies include an outflow-side filter medium body arranged at an outflow side of the filter element in the flow direction;
a safety filter covering the outflow face of the outflow-side filter medium body;
wherein at least one of the at least two filter medium bodies comprises an adsorbing filter medium with a granular adsorbing material; and
wherein the safety filter prevents a discharge of the granular adsorbing material at the outflow side of the filter element.

2. The filter element according to claim 1, wherein the outflow-side filter medium body comprises end faces arranged transversely to the outflow face of the outflow-side filter medium body, and wherein the outflow-side filter medium body comprises a circumferential lateral band arranged at the end faces.

3. The filter element according to claim 2, wherein the circumferential lateral band comprises an outflow-side rim in the flow direction and wherein the safety filter is seal-tightly connected to the rim of the circumferential lateral band.

4. The filter element according to claim 3, wherein the safety filter is fused or glued to the rim of the circumferential lateral band.

5. The filter element according to claim 3, wherein the rim of the circumferential lateral band projects in the flow direction at least in sections past the outflow face of the outflow-side filter medium body and forms a projecting rim.

6. The filter element according to claim 5, wherein the safety filter is glued or fused to an end face of the projecting rim.

7. The filter element according to claim 5, wherein the safety filter is arranged inside the projecting rim and is glued or fused to the projecting rim.

8. The filter element according to claim 2, wherein the safety filter is incorporated into a bonding of the circumferential lateral band to a filter medium of the outflow-side filter medium body.

9. The filter element according to claim 8, wherein the safety filter is glued into the bonding of the circumferential lateral band to the filter medium of the outflow-side filter medium body.

10. The filter element according to claim 2, wherein at least a part of the circumferential lateral band projects at least at two of the end faces opposed to each other past the outflow face of the outflow-side filter medium body and the part of the circumferential lateral band is folded over the safety filter.

11. The filter element according to claim 10, wherein the part of the circumferential lateral band is seal-tightly glued to the safety filter.

12. The filter element according to claim 1, wherein the at least two filter medium bodies include an inflow-side filter medium body arranged at an inflow side of the filter element in the flow direction, wherein the outflow-side filter medium body and the inflow-side filter medium body are arranged areally on top of each other, wherein the outflow face of the inflow-side filter medium body is arranged opposite the inflow face of the outflow-side filter medium body, and wherein a common seal surrounds radially outwardly a connection region of the outflow-side filter medium body and of the inflow-side filter medium body.

13. The filter element according to claim 12, wherein the outflow-side filter medium body comprises end faces arranged transversely to the outflow face of the outflow-side filter medium body, and wherein the safety filter covers the end faces of the outflow-side filter medium body and is connected to the common seal.

14. The filter element according to claim 13, wherein the safety filter is embedded in the common seal.

15. The filter element according to claim 12, wherein the safety filter is deep-drawn in a shape of the outflow-side filter medium body.

16. The filter element according to claim 1, wherein the at least two filter medium bodies include an inflow-side filter medium body arranged at an inflow side of the filter element in the flow direction, and wherein the inflow-side filter medium body is a particle filter and the outflow-side filter medium body is an adsorption filter.

17. The filter element according to claim 16, wherein the adsorption filter is an active carbon filter.
